(19) United States
(12) Patent Application Publication
(10) Pub. No.: US 2025/0030181 A1
(43) Pub. Date: Jan. 23, 2025

(54) CONDUCTOR TERMINAL

(71) Applicant: WAGO Verwaltungsgesellschaft mbH, Minden (DE)

(72) Inventors: Tobias DYCK, Espelkamp (DE); Stefan GRAEFEN, Minden (DE); Henning MEIER, Bueckeburg (DE)

(73) Assignee: WAGO Verwaltungsgesellschaft mbH, Minden (DE)

(21) Appl. No.: 18/774,744

(22) Filed: Jul. 16, 2024

(30) Foreign Application Priority Data
Jul. 17, 2023 (DE) 20 2023 103 986.3

(51) Int. Cl. H01R 4/48

(52) U.S. Cl. CPC H01R 4/4811; H01R 4/484

(57) ABSTRACT

A conductor terminal for connecting and interconnecting electrical conductors. At least one conductor insertion opening is provided for inserting a second electrical conductor into the housing such that at least one subsection of a second electrical conductor inserted into the housing through the at least one conductor insertion opening is arranged in the housing at an angle to at least one subsection of first electrical conductors that are each inserted into the housing through the insertion guide opening. At least one clamping device is arranged in the housing, via which a stripped section of a first electrical conductor inserted through an insertion guide opening is pressed in directly against a stripped section of the second electrical conductor inserted through the at least one conductor insertion opening.

This nonprovisional application claims priority under 35 U.S.C. § 119(a) to German Patent Application No. 20 2023 103 986.3, which was filed in Germany on Jul. 17, 2023, and which is herein incorporated by reference.

### BACKGROUND OF THE INVENTION

### Field of the Invention

The invention relates to a conductor terminal for connecting and interconnecting electrical conductors. A conductor terminal of this type may also be referred to as a connecting terminal.

### Description of the Background Art

A connecting terminal for connecting two electrical conductors directly to each other is known from DE 10 2021 108 627 A1, which corresponds to US 2024/0030625, which is incorporated herein by reference.

### SUMMARY OF THE INVENTION

It is therefore an object of the invention to specify an improved conductor terminal, with the aid of which a larger number of electrical conductors can also be connected to each other.

This object is achieved by a conductor terminal for connecting and interconnecting electrical conductors, which each have an inner electrically conductive core, which is surrounded by an insulating sheathing, the conductor terminal including a housing, which has insertion guide openings for guiding first electrical conductors into the housing and at least one conductor insertion opening for inserting a second electrical conductor into the housing, in such a way that at least a subsection of a second electrical of a second electrical conductor inserted into the housing through the at least one conductor insertion opening is arranged in the housing at an angle to at least a subsection of first electrical conductors which are inserted into the housing through an insertion guide opening, at least one clamping spring device being arranged in the housing, by means of which a stripped section of a first electrical conductor inserted through an insertion guide opening may be pressed in each case directly against a stripped section of a second electrical conductor inserted through the at least one conductor insertion channel.

The invention has the advantage that a connecting terminal having a comparatively simple structure is provided, in particular having very few individual parts, which is suitable for connecting and interconnecting a multiplicity of electrical conductors. In particular, multiple first electrical conductors may be connected directly to a second electrical conductor within the housing. A good electrical contacting may be ensured by a conductor direct connection of this type, since the contact point is rubbed free or rubbed smooth by the relative movement between the first and the second electrical conductor. A conductor direct connector having a multiplicity of connection possibilities is provided by the invention.

A direct connection between a transverse conductor (second electrical conductor), which is oriented transversely to the conductor insertion direction of the first electrical conductors into the housing, and multiple first electrical conductors is thus proposed. This transverse conductor may be designed as an electrical conductor which passes through multiple conductor terminals, so that multiple conductor terminals may be connected to each other at the same electrical potential by the transverse conductor.

Due to a construction of this type, a busbar, which is necessary for other conductor terminals, may also be omitted, since it may be replaced by the stripped section of the second electrical conductor. The conductor terminal according to the invention is provided with a particularly simple structure hereby and is economical to manufacture and to assemble. In addition, as discussed below, a certain part of the clamping spring device may also be used directly to fix the second electrical conductor.

The conductor terminal may be configured, in particular, to directly insert the first electrical conductor. Direct insertion means that the particular first electrical conductor may be inserted into the conductor terminal and connected to the second electrical conductor without an actuating element first having to be actuated manually to open the clamping point.

The conductor terminal can be configured so that at least a subsection, e.g., the stripped section, of a second electrical conductor inserted into the housing through the at least one conductor insertion opening is arranged in the housing at an angle, i.e. not in parallel, to at least a subsection, e.g., the particular stripped section, of first electrical conductors, which are each inserted into the housing through the insertion guide opening. In particular, the stripped section of the second electrical conductor, may thus be arranged at an angle, i.e., thus not in parallel, to stripped sections of the first electrical conductors. The angle may be a 90 degree angle, or an arbitrary angle between 1 and 179 degrees, in particular, between 50 and 140 degrees.

The conductor terminal can be configured so that electrical conductors of this type are connected thereto which each have an inner electrically conductive core, i.e., a wire or a litz wire, which is surrounded by an insulating sheathing. An electrical conductor of this type is also referred to as a single-core cable. The insulating sheathing may be made from, in particular, a plastic material.

The insertion guide openings may be configured, in particular, so that an electrical conductor is inserted into the housing through the insertion guide opening, led by its free end, in an insertion movement oriented in the longitudinal direction of the stripped section of the first electrical conductor and guided to the clamping point. A first electrical conductor may thus be connected with a linear insertion movement in the conductor terminal, similarly to a plug contact. The conductor insertion opening may be designed for the linear insertion of the second electrical conductor, similarly to the insertion guide opening, or it may be designed for a different type of guiding movement, e.g., a guiding movement in which the second electrical conductor is inserted into the housing or finally placed in the housing transversely to the longitudinal direction of its stripped section.

The housing with its insertion guide openings may be configured so that the first electrical conductors are insertable into the housing only in an insertion guide direction or a conductor insertion direction which runs at an angle, e.g. at a right angle, to the stripped section of the second electrical conductor arranged in the housing.

For example, the housing may have a conductor insertion opening only on one side, e.g., on a housing side of the main housing part. In this case, a stripped free end of the second electrical conductor is placed in the housing through the conductor insertion opening. The housing may have two conductor insertion openings, which may be arranged on housing sides facing diametrically away from each other. The second electrical conductor may then be guided continuously through the housing and is then placed in the housing or in the region of the clamping spring device with a central stripped section in order to provide the clamping points for the first electrical conductors.

The conductor terminal may be already fitted with a second electrical conductor in the delivery state.

The conductor terminal can be configured, e.g. by the shape of the housing and/or the clamping spring device, so that the stripped section of the second electrical conductor situated in the housing is arranged predominantly at a right angle to the stripped section of the first electrical conductors. For example, the second electrical conductor may also run in a direction relative to the first electrical conductors other than at the 90-degree angle outside the housing of the conductor terminal. For example, the second electrical conductor may be guided in parallel to the first electrical conductors outside the housing or also partially inside the housing. In one variant of the invention, the second electrical conductor may, for example, emerge from the housing at an angle, e.g. at a right angle, to the first electrical conductors. In another variant, the second electrical conductor may run in a bent manner within the housing after the stripped section arranged at the angle to the first electrical conductors and emerge from the housing at a different angle or in parallel to the first electrical conductors.

The clamping spring device can have an elastic spring tongue in each case for pressing a first electrical conductor against the second electrical conductor. This permits a reliable mechanical fixing and clamping of a particular first electrical conductor. In addition, a spring tongue of this type, which is present individually for each first electrical conductor, may be provided easily and cost-effectively, e.g., by means of the stamping process explained below.

The spring tongues can be brought out, i.e., stamped out, from a piece of spring steel sheet in the manner of leaf springs, the tongue roots being connected to each other via the spring steel sheet. In this way, the clamping spring device, including its individual spring tongues, may be very easily and cost-effectively manufactured, and it forms a robust construction. In particular, the clamping spring device may be manufactured as a single piece from a single piece of spring steel sheet.

The free ends of the spring tongues can each have a clamping edge, which is oriented in the direction of the second electrical conductor. This permits a particularly secure fixing of the first electrical conductors at the particular clamping point. The particular spring tongue may dig slightly into the material of the first electrical conductor by the clamping edge and thus acts as a barbed hook.

Two spring tongues in each case can be brought out from the piece of spring steel sheet mirror-symmetrically to a mid-plane in such a way that their tongue ends are spaced a distance apart, and the sheet metal material between the tongue ends is stamped out. This permits the provision of a relatively compact conductor terminal, which has a multiplicity of connecting locations for first electrical conductors.

The clamping spring device can have at least one receiving channel for receiving at least the stripped section of the second electrical conductor in a form-fitting and/or force-fitting manner. This has the advantage that the receptacle and fastener for the second electrical conductor may be already integrated into the clamping spring device, so that no additional component is needed therefor.

The receiving channel for the second electrical conductor can be arranged in a mid-plane between the groups of spring tongues. In the case of a comparatively compact conductor terminal having a multiplicity of connecting locations for first electrical conductors, a reliable contacting of the first electrical conductors arranged on both sides of the second electrical conductor may be ensured in this way. Two first electrical conductors may thus always be arranged in pairs on opposite sides of the second electrical conductor and connected directly thereto.

At least one conductor insertion opening can have a size of less than 50% of the surface area of the housing outer wall, on which the conductor insertion opening is situated, and/or less than five times the nominal cross-sectional surface area of a second electrical conductor specified for the conductor terminal. The conductor insertion opening is thus a comparatively small opening, i.e., the housing may be designed as a largely closed housing, so that the elements arranged therein are well protected against environmental influences, and a good protection against contact with the electrically conductive elements is established for the user. The conductor insertion opening may have, for example, essentially the same size as an insertion guide opening or a larger dimension. The insertion guide openings may be designed as essentially circular openings.

The at least one conductor insertion opening can have the shape of an elongated hole or slit, in particular an elongated hole or slit which is open on one side. This permits an easy insertion of the second electrical conductor into the housing as well as a subsequent final placement by a displacement of the second electrical conductor in the elongated hole or slit, e.g., when inserting the stripped section of the second electrical conductor into the receiving channel of the clamping spring device.

The housing can include a main housing part with a receiving opening and a cover part for closing the receiving opening. In this way, the housing may be implemented easily and using few components. In particular, the housing may include only the main housing part and the cover part. It is possible to insert the clamping spring device and possibly also the second electrical conductor with its stripped section into the main housing part through the receiving opening. The cover part may be placed onto the main housing part so that the receiving opening is closed. The insertion guide opening may be arranged in the cover part. The at least one conductor insertion opening may be arranged in the main housing part.

The housing, in particular the main housing part and the cover part, may be made from an insulating material, e.g., a plastic. The cover part may be latchable to the main housing part, for example, via latching element, and thus fixable on the main housing part.

The cover part can have a pressing section, by means of which a second electrical conductor inserted into the main housing part during the insertion of the cover part may be pressed into the receiving channel of the clamping spring device. In this way, the cover part additionally has a function as a tool for the final placement of the second electrical conductor in the clamping spring device. The cover part may thus be used as a pressing element for inserting the second electrical conductor. This facilitates a defined and user-friendly connection of the second electrical conductor in the conductor terminal.

The entire clamping spring device may be inserted as a separate component into the main housing part through the receiving opening. This also supports the easy assembly of the conductor terminal. In particular, individual clamping springs no longer have to be mounted, but instead the entire clamping spring device, including the multiple spring tongues, may be inserted as one component into the main housing part.

The conductor terminal may not have a metallic component or has only the clamping spring device as a metallic component. In particular, the conductor terminal may be designed without a busbar. The conductor terminal may be manufactured more easily and more cost-effectively hereby and also be easier to recycle.

The clamping points for connecting the electrical conductors can be formed directly between a stripped section of a particular first electrical conductor and a stripped section of the second electrical conductor. A good electrical transition between the individual conductors may be provided by a conductor direct connection of this type. In addition, any pollution layer that may be present, for example a corrosion layer, may be broken open during the insertion of the first electrical conductor, and the electrical conductor may be rubbed smooth.

The stripped section of a second electrical conductor inserted through the conductor insertion opening, against which a stripped section of a first electrical conductor inserted through the insertion guide opening may be pressed in each case, forms a busbar of the conductor terminal, via which the multiple first electrical conductors may be mechanically and electrically connected directly to the second electrical conductor and electrically conductively connected to each other.

The clamping spring device or at least its frame-shaped part of the spring tongues may be manufactured, for example, from a CrNi steel or an even more conductive material in comparison thereto, e.g., a Cu alloy (Cr—Ni—chromium nickel, Cu—copper).

First and second electrical conductors of the same type or of different types may be connected to the conductor terminal. For example, the first electrical conductors may be Cu conductors, and the second electrical conductors may also be Cu conductors. It is also possible that Al conductors are used as first electrical conductors. The second electrical conductor may be an Al conductor (Al—aluminum).

The first electrical conductors designed as Al conductors may use the second electrical conductor designed as an Al conductor as a contact point, so that the clamping spring device is essentially not effective for electrical contacting but only provides the contact and conductor holding forces.

The first electrical conductors designed as Cu conductors may additionally use the clamping spring device as an electrical contact point in the case of an electrical conductor made from Al, so that the second electrical conductor is essentially used only for support against the clamping force applied by the spring tongues.

If the second electrical conductor is designed as an Al conductor, it may also end on both sides in the housing. In this way, for example, a socket terminal may be advantageously provided, which is suitable for connecting Al conductors as well as Cu conductors as first electrical conductors, i.e., a mixed wiring is possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in a perspective view;

FIG. 2 shows the conductor terminal according to FIG. 1 in an exploded representation;

FIG. 3 shows the conductor terminal according to FIG. 1, prior to the final assembly of the housing components;

FIG. 4 shows the conductor terminal according to FIG. 1 in a top view;

FIG. 5 shows the conductor terminal according to FIG. 1 in a section plane B-B;

FIG. 6 shows the conductor terminal according to FIG. 1 in a section plane A-A;

FIG. 7 shows an example of a conductor terminal in a perspective view;

FIG. 8 shows the conductor terminal according to FIG. 7 in a section plane B-B;

FIG. 9 shows the conductor terminal according to FIG. 7 in an exploded representation;

FIG. 10 shows an example of a conductor terminal in a perspective view;

FIG. 11 shows the conductor terminal according to FIG. 10 in a section plane B-B;

FIG. 12 shows the conductor terminal according to FIG. 10 in an exploded representation;

FIG. 13 shows a conductor clamping spring in a perspective view;

FIG. 14 shows the clamping spring device according to FIG. 13 in a top view;

FIG. 15 shows the clamping spring device according to FIG. 13 in a section plane A-A.

### DETAILED DESCRIPTION

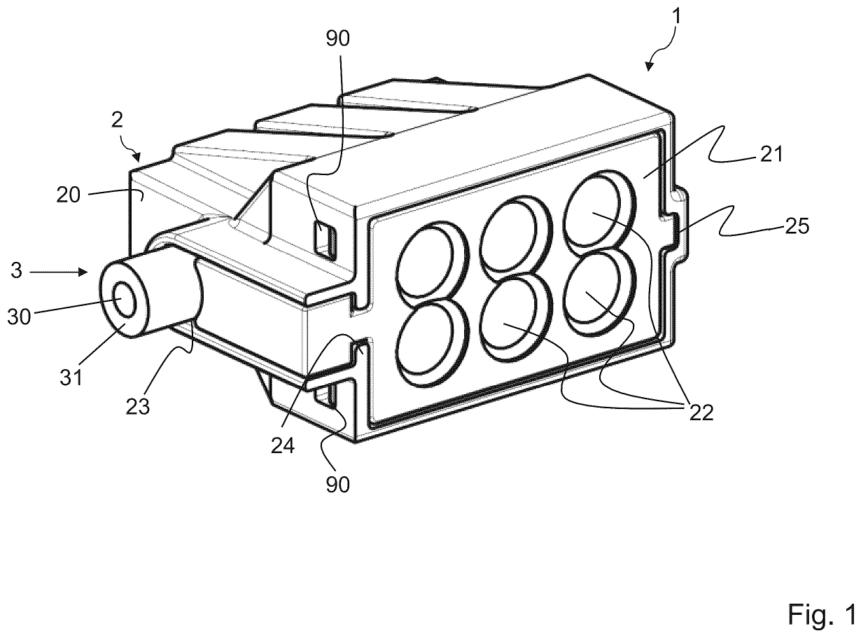

FIGS. 1 through 6 show a conductor terminal 1 in the form of a connecting terminal for connecting and interconnecting electrical conductors. Conductor terminal 1 includes, for example, a two-part housing 2, which comprises a main housing part 20 and a cover part 21. Conductor terminal 1 has multiple insertion guide openings 22, which in the illustrated example are arranged in cover part 21. insertion guide openings 22 are used to insert first electrical conductors 6 into housing 2. Housing 2 additionally has a conductor insertion opening 23, which is configured to insert a second electrical conductor 3 into housing 2. Conductor insertion opening 23 in the illustrated example is arranged on the side of housing 2, in particular on main housing part 20.

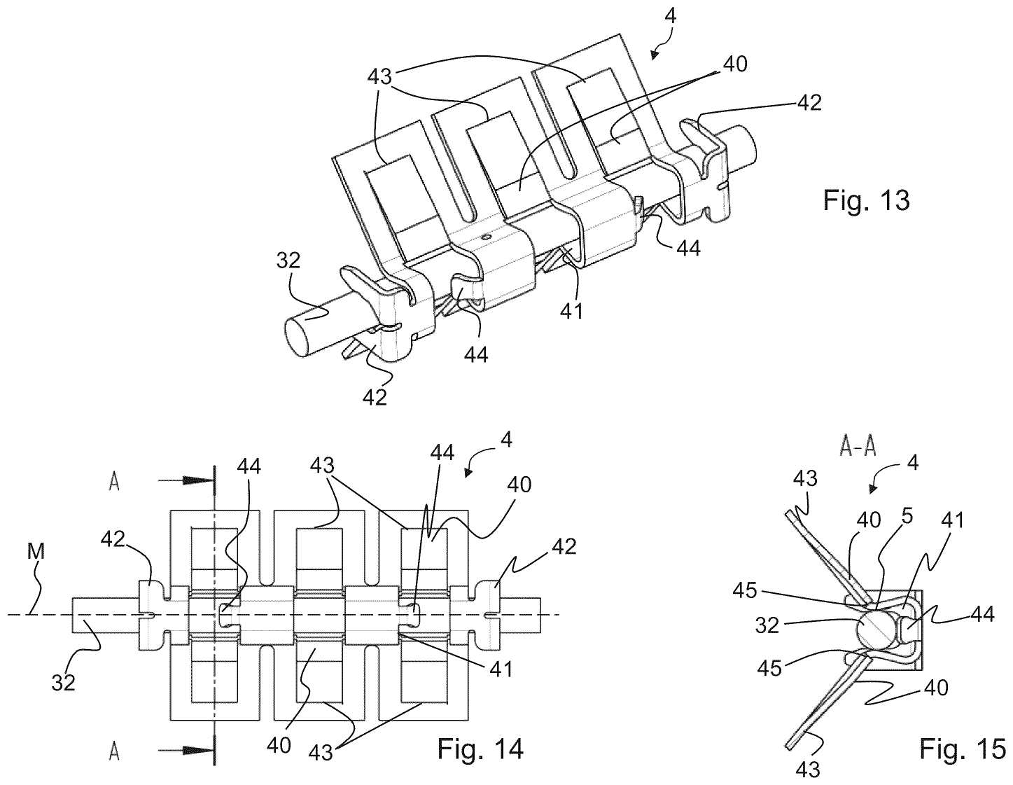

A clamping spring device 4 is situated in housing 2, which has a spring tongue 40, which is brought out from a piece of spring steel sheet in the manner of a leaf spring, for clamping a first electrical conductor 6 inserted in each case through an insertion guide opening 22 on second electrical conductor 3. As is apparent, in particular, in FIGS. 13 through 15, clamping spring device 4 is designed to be essentially mirror-symmetrical to a mid-plane M, at least in such a way that two opposite spring tongues 40 in each case are brought out from the spring steel sheet symmetrically to mid-plane M. Clamping spring device 4 has a receiving channel 41 in mid-plane M for receiving stripped section 32 of second electrical conductor 3 in a form-fitting and/or force-fitting manner.

Conductor terminal 1 is configured in such a way that a stripped section 62 of a first electrical conductor 6 is pressed in each case against a stripped section 32 of second electrical conductor 3 with the aid of clamping spring device 4 or a spring tongue 40. First electrical conductor 6 is designed as an insulated cable having an electrically conductive core 60 and an insulating sheathing 61 surrounding electrically conductive core 60. Second electrical conductor 3 is designed as an insulated cable having an electrically conductive core 30 and an insulating sheathing 31 surrounding electrically conductive core 30.

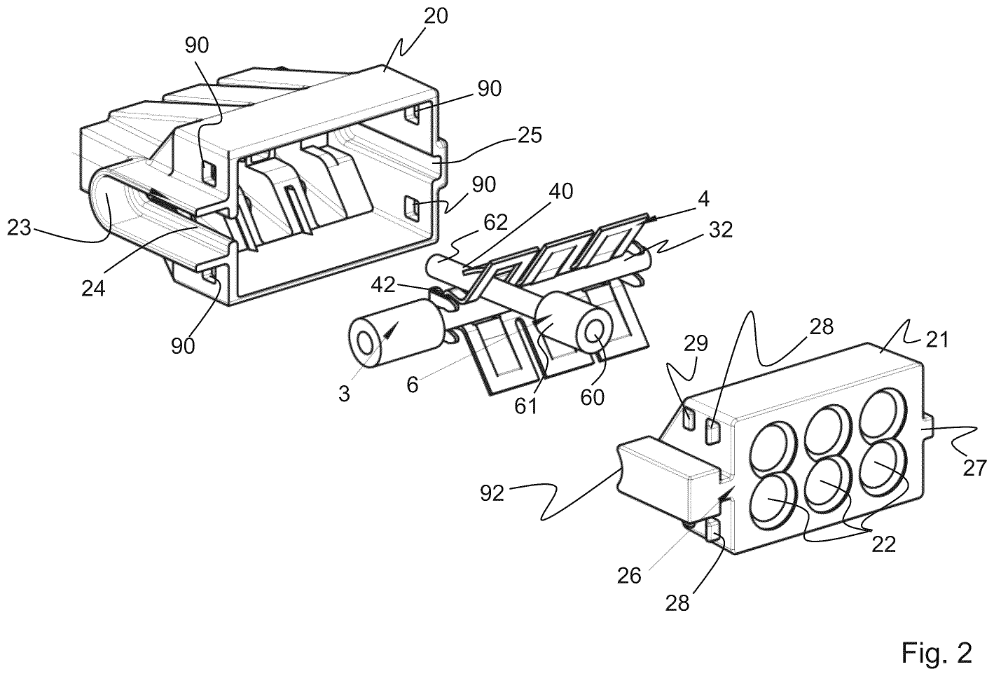

It is apparent, for example in FIG. 2, that conductor insertion opening 23 is designed as an elongated slit in main housing part 20, which is open toward one side. Second electrical conductor 3 may be inserted into housing 2 or main housing part 20 not yet closed with the aid of cover part 21 in a direction in which first electrical conductor 6 is inserted into housing 2 through insertion guide openings 22 in a conductor insertion direction L, thus transversely to its longitudinal extension direction. It is advantageous if clamping spring device 4 is first inserted into main housing part 20 and second electrical conductor 3 is then inserted therein. Cover part 21 may then be finally guided into main housing part 20. Cover part 21 has a pressing section 92, formed, for example, by an end face of cover part 21, with the aid of which cover part 21 then presses second electrical conductor 3 in the direction of clamping spring device 4 and, in particular, into receiving channel 41.

A guide arrangement 24 in the manner of a longitudinal guide is formed on the one side of main housing part 20 in the region of conductor insertion opening 23, and a guide arrangement 25 in the manner of a guide rail is formed on the other side, on which main housing part 20 is designed to be closed. Guide elements 26, 27 are formed on cover part 21. Guide element 26 is configured to be guided along longitudinal guide 24. Guide element 27 is configured to be guided along guide rail 25. In this way, cover part 21 may be inserted into main housing part 20 in a targeted manner and without tilting and guide second electrical conductor 3, including its stripped section 32, into receiving channel 41.

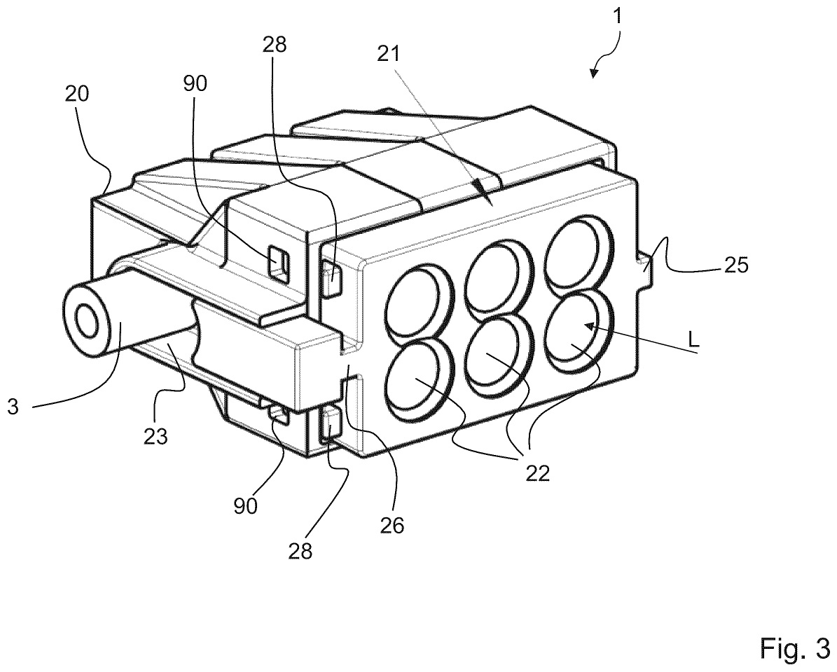

Housing parts 20, 21 may be latched to each other. Latching elements 90 are formed on main housing part 20 for this purpose. Corresponding latching elements 28 assigned to latching elements 90 are formed on cover part 21. Pre-latching elements 29 are additionally formed farther to the front on cover part 21 in the insertion direction of cover part 21 into main housing part 20. Pre-latching elements 29 are used to hold cover part 21 in an initial pre-latching position, which is illustrated in FIG. 3, while the latter is being inserted into main housing part 20. In this pre-latching position, second electrical conductor 3, including its stripped section 32, may be inserted into housing 2 through conductor insertion opening 23 without any special application of force, stripped section 32 initially not yet being received in receiving channel 41. Only afterwards, by pressing on cover part 21, is the latter moved farther into main housing part 20 until latching elements 28 engage with latching elements 90. During this movement, cover part 21 acts as a pressing element for pressing stripped section 32 of second electrical conductor 3 into receiving channel 41.

It is apparent that at least the sections of first and second electrical conductors 3, 6 arranged in housing 2, in particular their stripped sections 32, 62, are arranged at an angle to each other, e.g., at an essentially right angle.

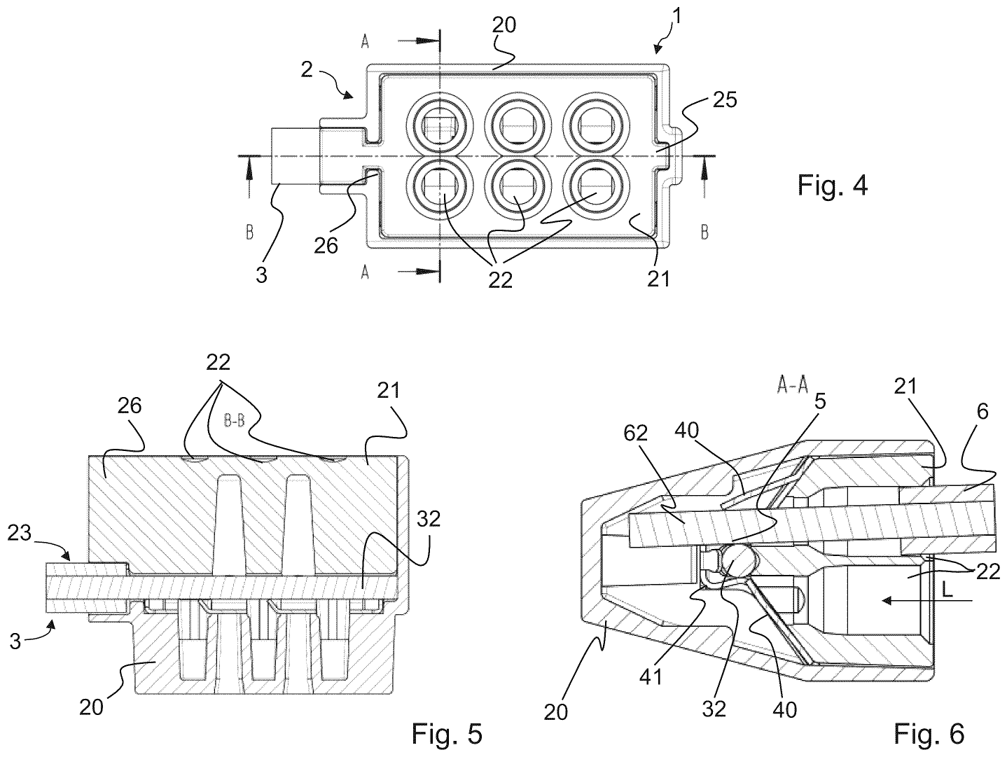

FIG. 4 shows conductor terminal 1 according to FIG. 1 in a top view of the housing side on which insertion guide openings 22 are arranged. Two section planes A-A and B-B are also illustrated in FIG. 4. FIG. 5 shows conductor terminal 1 in a sectional view in section plane B-B marked in FIG. 4. FIG. 6 shows conductor terminal 1 in a sectional view in section plane A-A marked in FIG. 4.

It is clearly apparent in FIG. 6 that clamping point 5, at which stripped section 62 of first electrical conductor 6 is clamped to stripped section 32 of second electrical conductor 3 by means of the spring force of spring tongue 40, is formed directly between first and second electrical conductors 3, 6, i.e., no elements, in particular no busbar, are arranged therebetween. Instead, second electrical conductor 3 or, specifically its stripped section 32, forms a kind of busbar for connecting the multiple first electrical conductors 6 to be guided through insertion guide openings 22.

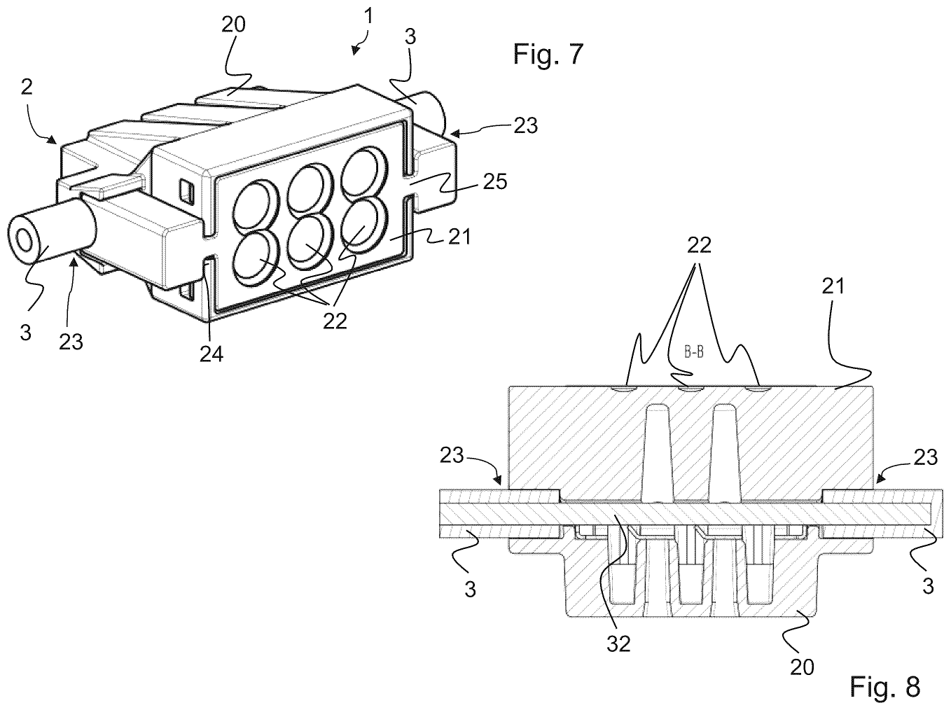

FIG. 7 shows an example of a conductor terminal 1, which differs from the example in FIGS. 1 through 6 in that housing 2 has a conductor insertion opening 23 not only on one side, but additionally has a further conductor insertion opening 23 on a housing side diametrically opposed thereto. While this construction would, in principle, make it possible to insert a separate second electrical conductor 3 through each conductor insertion opening 23, the design is more advantageous, in which one continuous second electrical conductor 3 is inserted, which extends through entire housing 2, as is clearly apparent in FIG. 8.

FIG. 8 shows the conductor terminal according to FIG. 7 in a section plane comparable to FIG. 5. In this way, a kind of chain of multiple conductor terminals 1 of the type described, which are all at the same electrical potential, due to continuous second electrical conductor 3, may be created by a continuous second electrical conductor 3.

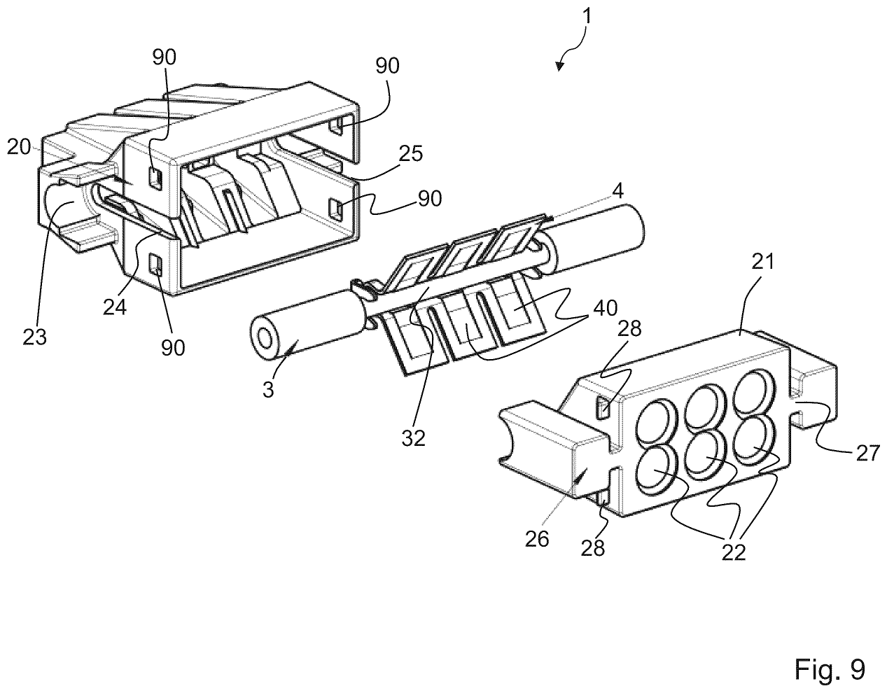

FIG. 9 illustrates the construction of the conductor terminal according to FIG. 7 in an exploded representation comparable to FIG. 2. It is apparent that main housing part 20 has slitted conductor insertion openings 23 essentially mirror-symmetrically on both sides as well as guide arrangements 24, 25, open on both sides, which are used to guide the guide elements 26, 27 of cover part 21. In other respects, conductor terminal 1 may have a design comparable to that of conductor terminal 1 according to FIGS. 1 through 6.

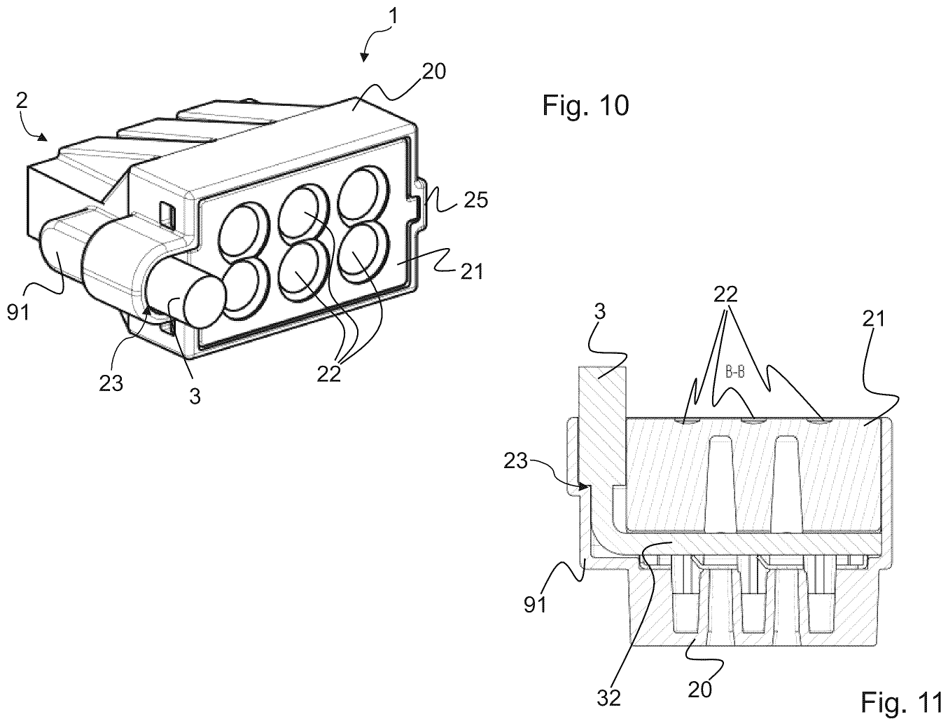

FIG. 10 shows an example of conductor terminal 1, which, similarly to the example in FIGS. 1 through 6, has a conductor insertion opening 23 only on one side, the other side being designed to be closed, similarly to the example in FIGS. 1 through 6. In contrast to the example in FIGS. 1 through 6, conductor terminal 1 according to FIG. 10 has a bent insertion guide channel 91 on housing 2, through which second electrical conductor 3 is guided in a curved manner within housing 2 and leaves housing 2 in a direction which is in parallel to conductor insertion direction L of first electrical conductors 6. First electrical conductors 6 are thus arranged in parallel to the emerging portion of second electrical conductor 3 in an assembled conductor terminal 1.

This is clarified, in particular, by FIG. 11 in the sectional representation in section plane B-B, which is a sectional view comparable to FIG. 5. It is apparent that the portion of second electrical conductor 3, or its stripped section 32, situated in the region of receiving channel 41 runs at an angle to inserted first electrical conductors 6, like in the examples discussed above, in particular at a right angle.

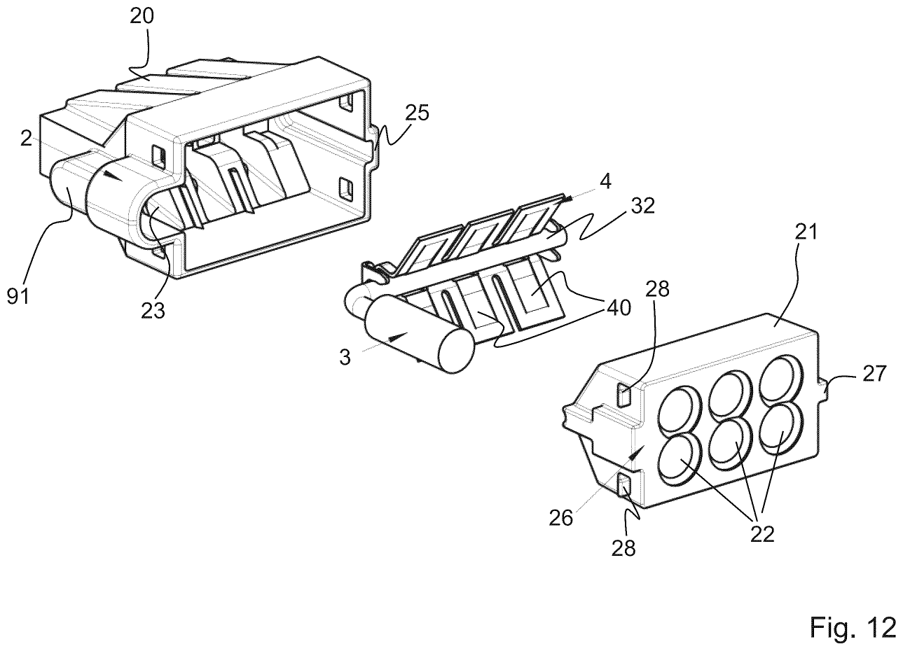

FIG. 12 shows conductor terminal 1 according to FIG. 10 in an exploded view similar to FIG. 2.

FIGS. 13 through 15 show different views of clamping spring device 4, including stripped section 32 of second electrical conductor 3 received in receiving channel 41. It is apparent that clamping spring device 4 is designed as a stamped bent part made from a piece of spring steel sheet, spring tongues 40 being brought out from the spring steel sheet in the matter of leaf springs, and tongue roots 43 being connected to each other via the spring steel sheet. In the region of receiving channel 41, fork-shaped clamping devices 42 are each formed on the ends, also formed as a single piece from the spring steel sheet, by means of which stripped section 32 is held in receiving channel 41 in a form-fitting and/or force-fitting manner. To ensure a defined placement of second electrical conductor 3 in receiving channel 41, additional spacers 44 are provided, which may also be formed as a single piece from the spring steel sheet and which fix stripped section 32 in a position, in which direct insertion of first electrical conductors 6 together with spring tongues 40 is possible, i.e., particular spring tongue 40 is slightly deflected by inserting a first electrical conductor 6, and first electrical conductor 6 is guided to clamping point 5 in a targeted manner by the chamfer formed as a result of the round cross-sectional shape of stripped section 32.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal for connecting and interconnecting an electrical conductor, which each have an inner electrically conductive core, which is surrounded by an insulating sheathing, the conductor terminal comprising:
a housing;
insertion guide openings formed in the housing to guide first electrical conductors into the housing;
at least one conductor insertion opening for inserting a second electrical conductor into the housing such that at least one subsection of a second electrical conductor inserted into the housing through the at least one conductor insertion opening is arranged in the housing at an angle to at least one subsection of first electrical conductors that are each inserted into the housing through the insertion guide opening; and
at least one clamping device arranged in the housing, via which a stripped section of a first electrical conductor inserted through an insertion guide opening is pressed in directly against a stripped section of the second electrical conductor inserted through the at least one conductor insertion opening.

2. The conductor terminal according to claim 1, wherein the clamping spring device has an elastic spring tongue for pressing a first electrical conductor against the second electrical conductor.

3. The conductor terminal according to claim 2, wherein the spring tongues are brought out or stamped out from a piece of spring steel sheet in the manner of leaf springs, the tongue roots being connected to each other via the spring steel sheet.

4. The conductor terminal according to claim 2, wherein the free ends of the spring tongues each have a clamping edge, which is oriented in the direction of the second electrical conductor.

5. The conductor terminal according to claim 3, wherein two spring tongues in each case are brought out from the piece of spring steel sheet mirror-symmetrically to a mid-plane such that their tongue ends are spaced a distance apart, and the sheet metal material between the tongue ends is stamped out.

6. The conductor terminal according to claim 1, wherein the clamping spring device has at least one receiving channel for receiving at least the stripped section of the second electrical conductor in a form-fitting and/or force-fitting manner.

7. The conductor terminal according to claim 6, wherein the receiving channel for the second electrical conductor is arranged in a mid-plane between the groups of spring tongues.

8. The conductor terminal according to claim 1, wherein the at least one conductor insertion opening has a size of less than 50% of the surface area of the housing outer wall on which the conductor insertion opening is situated, and/or less than five times the nominal cross-sectional surface area of a second electrical conductor specified for the conductor terminal.

9. The conductor terminal according to claim 1, wherein the at least one conductor insertion opening has the shape of an elongated hole or slit, in particular an elongated hole or slit which is open on one side.

10. The conductor terminal according to claim 1, wherein the housing includes a main housing part with a receiving opening and a cover part for closing the receiving opening.

11. The conductor terminal according to claim 10, wherein the insertion guide openings are arranged in the cover part.

12. The conductor terminal according to claim 10, wherein the cover part has a pressing section, via which a second electrical conductor guided into the housing is pressed into the receiving channel of the clamping spring device when the cover part is inserted into the main housing part.

13. The conductor terminal according to claim 10, wherein the at least one conductor insertion opening is arranged in the main housing part.

14. The conductor terminal according to claim 10, wherein the clamping spring device is inserted as a separate component into the main housing part through the receiving opening of the main housing part.

15. The conductor terminal according to claim 1, wherein the conductor terminal does not have a metallic component or has only the clamping spring device as a metallic component.

16. The conductor terminal according to claim 1, wherein the clamping points for connecting the electrical conductors are formed directly between a stripped section of a particular first electrical conductor and a stripped section of the second electrical conductor.

17. The conductor terminal according to claim 1, wherein the stripped section of a second electrical conductor inserted through the conductor insertion opening, against which a stripped section of a first electrical conductor inserted through the insertion guide opening is pressed, forms a busbar of the conductor terminal, via which the multiple first electrical conductors is mechanically and electrically connected directly to the second electrical conductor and electrically conductively connected to each other.
